(19) United States
(12) Patent Application Publication
(10) Pub. No.: US 2024/0028115 A1
(43) Pub. Date: Jan. 25, 2024

(54) METHOD FOR ADAPTING A HUMAN-MACHINE INTERFACE

(71) Applicant: Orange, Issy-Les-Moulineaux (FR)

(72) Inventors: Cédric FLOURY, Chatillon Cedex (FR); Violaine MERCIER, Chatillon Cedex (FR); Jean François LETELLIER, Chatillon Cedex (FR)

(21) Appl. No.: 18/357,052

(22) Filed: Jul. 21, 2023

(30) Foreign Application Priority Data
Jul. 22, 2022 (FR) 2207575

(51) Int. Cl. G06F 3/01; G09B 17/04

(52) U.S. Cl. CPC G06F 3/013; G09B 17/04

(57) ABSTRACT

A method implemented by a computing device, the method including a limitation of the rendering of at least one notification on at least one human-machine interface of the device when content is being consumed in an environment of the device.

### CROSS-REFERENCE TO RELATED APPLICATIONS

This application claims foreign priority to French Patent Application No. FR 2207575, entitled “METHOD FOR ADAPTING A HUMAN-MACHINE INTERFACE” and filed Jul. 22, 2022, the content of which is incorporated by reference in its entirety.

### BACKGROUND

### Technical Field

This disclosure relates to the field of human-machine interfaces.

### Prior Art

Many computing devices have human-machine interfaces. A Human-Machine Interface (HMI) makes it possible to interact with the environment of the computing device by outputting information from the human-machine interface, for example via screens, speakers, etc., and/or by inputting information into it, for example via keyboards, cameras, or microphones.

Computing devices with human-machine interfaces are widely used and can for example be smart phones, smart watches, tablets, personal computers, servers, on-board computers for vehicles, smart glasses, or in general any computing device having a human-machine interface. The human-machine interface may be integrated into the device itself, and/or be composed of remote devices connected to the computing device.

There are needs for improvement to the human-machine interfaces of such devices, to better adapt them to the needs of users of these devices.

### SUMMARY

This disclosure improves the situation.

A method implemented by a computing device is proposed, the method comprising: a limitation of the rendering of at least one notification on at least one human-machine interface of said device when a content is being consumed in an environment of said device.

“At least one human-machine interface of said device” is understood to mean at least one human-machine interface coupled to the device, meaning a human-machine interface integrated into the device, or a human-machine interface connected to the device by means of wired or wireless communications.

A human-machine interface integrated into the device can for example be: a touchscreen integrated into a tablet;
a speaker integrated into the device;
a webcam integrated into the device;
a microphone integrated into the device;
overlay display devices integrated into smart glasses;
a vibration motor integrated into the device;
a presence sensor integrated into the device;
etc.
A human-machine interface connected to the device can for example be:
a keyboard connected to the device in a wired or wireless manner;
a mouse connected to the device in a wired or wireless manner;
a screen connected to the device in a wired or wireless manner;
a video projector connected to the device in a wired or wireless manner;
a motion, position, or presence sensor in a second device such as a smart phone or smart watch connected to the computing device;
more generally, any sensor which is not located in the device and whose measurements are transmitted to the computing device by a wired or wireless connection.

These human-machine interfaces are provided solely as non-limiting examples, and the development is more generally applicable to any type of human-machine interface coupled to the computing device.

“Consuming content in an environment of said device” is understood to mean reading or writing content in an environment of the device. Reading can for example be listening in the case of audio content, or reading a text in the case of email type content, or reading external content such as text written on paper or video content rendered by and/or near the human-machine interface, or others.

Writing is understood to mean a modification of content, such as writing an email or a text file, recording an audio file, or modifying external content such as a sheet of paper, for example by writing or drawing on the sheet.

The environment of the device can be the device itself, if the content is located on the device, such as a file stored on the device. It is also possible that it is a network environment, for example in the case of a file stored in a local area network and read by the device, or content played via a streaming service. Lastly, the environment of the device can be a physical environment of the device, for example in the case of content on a physical medium external to the device, read via a device such as glasses.

Human-machine interfaces can be configured to send notifications when certain events occur, in particular events likely to be of interest to a user of the computing device. In the present application, notification is understood to mean an activation of at least one outputting human-machine interface of a device, capable of “notifying” (i.e. alerting, informing) a user of the occurrence of an event. For example, a notification can be issued in the event of receipt of an email, an SMS message, or an instant messaging message, receipt of a notice concerning the user in an application, the appearance of a new occurrence of an object searched for by the user.

In general, many applications or software installed on the device can issue notifications, according to their utility for the user of the device. Notifications can use all the options for outputting information from the human-machine interface, and can for example take the form of a bubble appearing on the screen and possibly containing text, a sound, a video, or a combination thereof. A notification relating to a message or email is typically presented in the form of a bubble appearing with an excerpt from the message, and if applicable the title of the email, possibly accompanied by a sound.

Although notifications allow the user to be instantly informed of events likely to be of interest, in certain cases the issuing of a notification can interrupt or more generally distract the user during the use of content. For example, when the user is focused on reading a complex text or email, sending a notification while the user is reading can be distracting. The proliferation of applications which issue notifications makes the sending of notifications more frequent, and therefore the opportunities for notifications to break the user's concentration.

Limitation (or reduction) of the at least one notification is understood to mean an action aimed at making this notification less noticeable for a user. This reduction can vary depending on the embodiments.

One example of limitation can be blocking the notification, carried out for example before it is issued via the at least one human-machine interface (so as not to activate the human-machine interface, for example not emitting any sound on any speaker of the device and not displaying any information related to this notification on any screen linked to the device).

In some embodiments, a limitation can comprise an alteration (for example a reduction in intensity) of at least one among the audio, image, or video components of the notification (compared to a first configuration for rendering the notification when there is no content consumption). This can, for example, make it possible to keep a notification action, but reduce its perception by the user. For example, in some embodiments, the limitation may include altering a rendering of the notification in order to play a sound more softly, display bubbles that are smaller with briefer text and/or are more transparent, reduce the time the notification is displayed or issued; and/or deleting at least certain actions on the at least one human-machine interface that are associated with the notification. This alteration can for example be carried out before any rendering of the notification, for example so as to use rendering parameters that are different from the default rendering parameters defined for notifications from the application from which the notification (to be altered) is sent. This alteration may correspond for example to deleting at least one activation of at least one output from the at least one human-machine interface normally associated with the notification. For example, during the limitation, a notification which by default consists of displaying a bubble and issuing a sound may consist only of displaying the bubble, without issuing a sound.

Another way to make a notification less noticeable, in some embodiments, can be to modify the duration of the notification or to delay it. Notification can be delayed in different ways. For example, it can be delayed by a constant or variable duration (for example predefined), or delayed to the end of the content consumption. In the case where multiple contents are consumed in succession, the notification can be delayed either to the end of the consumption of the content that is current at the time the notification occurs, or to the end of the consumption of the multiple contents.

The different types of limitations can be combined. For example, a notification can be both delayed and altered. The delayed notification can thus be identical to the initial notification, or altered.

These examples are provided in a non-limiting manner, and any action which allows reducing and/or delaying the impact of a notification on a user can be used within the framework of this development.

Limitation of at least one notification during content consumption allows the user to remain focused on this content during its consumption, without being distracted by the notification. For example, in one embodiment of the development, when reading an email, the user will not be bothered by notifications occurring in the form of bubbles or sounds. Limitation according to the development does not require manual intervention by the user, and therefore allows the user to remain focused on the content being consumed without having to manually configure his or her interface, unlike certain prior art solutions which only allow the user to manually change (in advance) the settings for issuing notifications. However, in practice, the manual management of notifications does not allow the user to fine-tune the activation/deactivation of notifications. In particular, the user will find it difficult to take the step of automatically deactivating notifications as soon as the user begins to use content on which he or she wishes to focus, and automatically reactivating notifications as soon as the user has finished using the content so as to benefit from the notifications and alerts he or she usually uses.

Unlike prior art solutions, the method according to the development therefore allows the user to remain focused when consuming content, and to benefit from notifications the rest of the time, without needing to implement complex manual interventions.

According to another aspect, a computer program is provided comprising instructions for implementing all or part of a method as defined herein when this program is executed by a processor.

According to another aspect, a non-transitory, computer-readable storage medium is provided on which such a program is stored.

According to another aspect, a computing device is proposed comprising at least one processor configured to execute all or part of a method as defined in this application.

The features set forth in this application may optionally be implemented, independently of each other or in combination with each other:

Thus, in some embodiments, the method comprises detecting the start of said consumption upon detecting access to said content.

In some embodiments, said limitation comprises delaying the rendering of the at least one notification.

Delaying the rendering of the at least one notification can include rendering the at least one notification at a time subsequent to the occurrence of the event that is the object of the notification (for example at a time subsequent to when the notification is generated or issued), rather than at the time when the notification is generated or issued.

The notification is thus rendered later on, allowing the user to remain focused at the current time.

The subsequent time can be determined in different ways. For example, the rendering of the notification can be delayed by a constant or variable duration (for example predefined), or by a duration corresponding to an estimated duration of the content consumption, relative to the moment when the event that is the object of the notification occurred, and/or to the moment the notification is generated or issued.

The rendering of the notification can also be performed when a subsequent event occurs that is related to content consumption. For example, the rendering of the notification can occur upon detecting the end of content consumption (for example, upon detecting the closing of the content, or upon detecting the end of active consumption by the user (for example, upon detecting that scrolling has stopped or that eye movements have stopped). The notification is thus rendered automatically when the user has finished with active consumption and is no longer at risk of being disturbed.

The delayed notification may be identical to the initial notification, or may be altered in order to limit the impact of the rendering of the notification on the user, for example according to one of the alteration examples discussed in this application.

In some embodiments, the method comprises a characterization of the content, and said limitation is conditional on said characterization.

In some embodiments, the characterization of the content corresponds to defining one or more characteristics of the content.

In some embodiments, said limitation is implemented for a duration which takes into account said consumed content.

In some embodiments, said duration of said limitation is at least a function of a size of said content.

In some embodiments, when the content comprises text data, said duration of said limitation is at least a function of a length of said text data.

In some embodiments, said duration of said limitation is at least a function of a rate of consumption of said content.

In some embodiments, when the content comprises text data, said duration of said limitation is at least a function of an estimated text reading speed.

In some embodiments, the method comprises detecting a start of said consumption and/or monitoring said consumption via an analysis of measurements coming from at least one activity sensor for sensing activity of a consumer of said content.

In some embodiments, the measurements comprise eye tracking for said consumer.

In some embodiments, the analysis of eye tracking measurements is at least a function of said characterization of the content.

In some embodiments, the content is rendered on a physical medium that is separate from the at least one human-machine interface.

In some embodiments, content consumption includes at least one among reading and writing content in text form.

### BRIEF DESCRIPTION OF DRAWINGS

Other features, details, and advantages will become apparent upon reading the detailed description below, and upon analyzing the appended drawings, in which:

FIG. 1a shows an example of a computing device according to some embodiments.

FIG. 1b shows an example of a computing device according to some embodiments.

FIG. 1c shows an example of a computing device according to some embodiments

FIG. 2 shows a first example of a method according to some embodiments.

FIG. 3 shows a second example of a method according to some embodiments.

FIG. 4 shows a third example of a method according to some embodiments.

### DETAILED DESCRIPTION OF CERTAIN ILLUSTRATIVE EMBODIMENTS

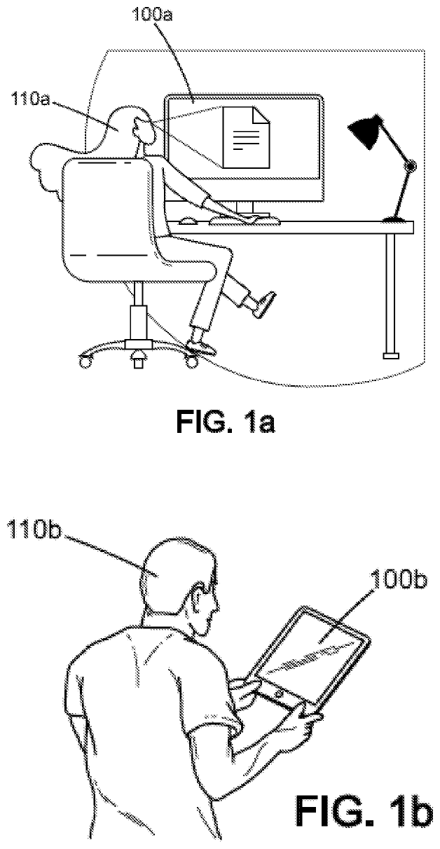

Reference is now made to FIG. 1a.

FIG. 1a represents an example of a computing device according to some embodiments of the development.

In the example illustrated, the computing device is a personal computer 100a.

Personal computer 100a allows a user 110a to consume content and to interact via at least one Human-Machine Interface (HMI).

In the example of FIG. 1a, the content that can be consumed by user 110a can be for example:
Text content (such as emails, Word or pdf documents, e-books, etc.);
Audio/video content (such as audio/video streaming services, videos on demand, videos or music stored on the computer, etc.);
Or more generally any electronic content consumable by a user of a personal computer.

The at least one human-machine interface can comprise at least one human-machine input interface (allowing the device to acquire information from a user of the device) and/or at least one human-machine output interface (allowing the device to “render” (or reproduce) information for a user of the device), such as a keyboard, a mouse, a screen, a webcam, an eye tracking device (eye tracker), speakers, a microphone, and/or sensors.

These human-machine interfaces can in particular be used by a user of the computing device in order to consume content and to provide instructions to the computing device. In some embodiments of the development, they also allow detecting the start of consumption and to monitor consumption, for example by means of eye tracking or a presence detector.

Content consumption can consist of reading content, for example reading a text file or watching a video, and writing content, for example editing a text file, touching up an image, or editing a video.

The human-machine interfaces also make it possible to provide user 110a with notifications. These notifications enable the user to be informed of events such as the arrival of an email message or the appearance of new search results. They can, for example, take the form of text bubbles appearing on a screen, sounds, vibrations, or more generally any sensory information that can be generated by a human-machine interface and allow the user to become aware of the occurrence of an event.

At least one application executed by personal computer 100a may for example be configured to send notifications that can use at least one of the human-machine interfaces accessible via personal computer 100a.

Reference is now made to FIG. 1B.

FIG. 1B represents a second example of a computing device according to some embodiments of the development, where the computing device is a touchscreen tablet 100b.

Touchscreen tablet 100b allows for example a user 110b to consume content and to interact via at least one Human-Machine Interface (HMI).

Similarly to personal computer 100a, tablet 100b can allow user 110b to consume many types of electronic content, such as textual, audio, image, or video content.

The at least one human-machine interface can comprise human-machine input and output interfaces, such as a keyboard, a touchscreen, touch-sensitive buttons, motion sensors, a webcam, an eye tracking device, speakers, a microphone. Exemplary human-machine interfaces can also integrate devices connected to tablet 100b, for example a smart watch or smart glasses equipped with sensors.

Reference is now made to FIG. 1c.

FIG. 1c represents a third example of a computing device according to some embodiments of the development.

The computing device is a pair of smart glasses 100c.

The pair of glasses 100c can allow for example a user 110c to consume content on a physical medium 120c that is different from the at least one human-machine interface (i.e. not part of the human-machine interfaces of the device, and not paired or connected by wire or wirelessly to the device or to the HMI). The pair of glasses 100c can allow consuming different types (for example any type) of content that can be consumed visually, for example such as:
text written or in the process of being written on a non-electronic medium (e.g. on paper (book, newspaper, etc.), cardstock, etc.);
a displayed image, or video broadcast in a public space or in a private projection space, for example an advertisement or a film projected via a video projector or a television screen;

The physical medium can thus be an electronic medium, for example an electronic screen, or a non-electronic medium, for example a sheet of paper. Content consumption can consist both of reading content, for example reading a newspaper or watching a video, and writing content, for example handwriting text on a sheet of paper.

The pair of smart glasses 100c may further comprise, at least in certain embodiments, computing capabilities allowing it to run applications, and connection capabilities allowing it to interact with other computing devices such as a communication terminal (for example a smart phone) or a smart watch.

Smart glasses 100c can also make it possible to send notifications to user 110c via at least one human-machine interface which can be for example:
a display means for displaying superimposed data on the glasses. Such display means allow displaying messages or icons that the user sees through the glasses, superimposed on what they are looking at. Such a display means can for example be a projection onto the glasses, or OLED micro-displays arranged on the glasses;
a speaker enabling sound to be emitted close to the user's ears;
vibrating devices which allow the user to feel vibrations.

The at least one human-machine interface can also comprise human-machine input interfaces, which can be for example:
an eye tracking device integrated into the glasses;
a keyboard or touchscreen communicating with the glasses;
a motion or presence sensor integrated into the glasses.

According to the examples illustrated, each of computing devices 100a, 100b, and 100c can be equipped with computing capabilities. Computing capabilities can for example include processors capable of executing code instructions that may be part of applications or software.

Although the issuing of notifications generally allows the user to have real-time access to the occurrence of events likely to be of interest to the user, the notifications can distract him or her during content consumption.

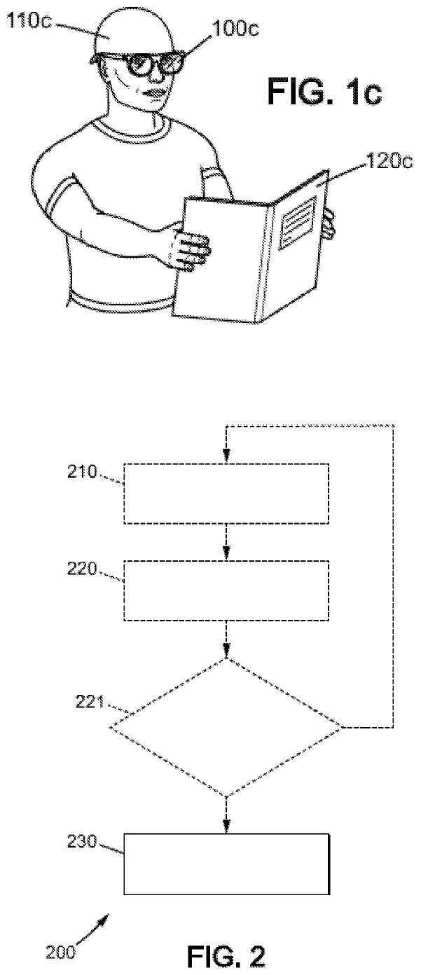

In order to allow the user to benefit from notifications in general, without being distracted when consuming content, devices 100a, 100b, and 100c are configured to implement the method according to one of embodiments of the development, for example as described with reference to FIGS. 2, 3, and 4.

Devices 100a, 100b, and 100c are given solely as examples of computing devices able to implement the development. The development is more generally applicable to any computing device able to send notifications via a human-machine interface, whether the at least one human-machine interface is internal or external to the device.

FIG. 2 shows a first example of a method 200 according to some embodiments of this application.

Method 200 is a method implemented by a computing device such as devices 100a, 100b, 100c.

Implementation of the method is not limited to devices 100a, 100b, and 100c however, and the method can be implemented by any computing device able to issue notifications on at least one human-machine interface that may or may not be part of the device.

According to FIG. 2, method 200 can comprise a step 230 of limiting the rendering of at least one notification on at least one human-machine interface of said device during content consumption in an environment of said device.

Limitations on the at least one notification can also be applied jointly to several actions, on the human-machine interface(s), representative of the notification. For example, a notification which by default is issued in the form of a wide bubble with text accompanied by a loud sound could, in its limited form, be issued in the form of a narrow bubble with limited text (reducing the intensity of the bubble), or even with no sound (reducing the actions by deactivating the sound output).

Depending on the embodiments, the at least one notification may be limited permanently (for example blocked), or on the contrary be completely reproduced for the user (without limitation) at the end of the consumption (or of the consumption duration (for example the estimated duration of consumption as explained below)). For example, if a notification is blocked while content is being consumed, it can be either permanently blocked or issued as soon as the content consumption ends, i.e. delayed until the end of the consumption (or of the consumption duration (for example the estimated duration of consumption as explained below)). Similarly, if at least one action associated with the notification has been limited during the consumption (or the duration, for example estimated, of this consumption), (for example deleted or of reduced intensity), it may be carried out in a delayed manner, with or without limitation, at the end of consumption, or on the contrary may remain limited or not be carried out at all, at the end of consumption.

For example, in some embodiments, an alert sound not emitted during consumption may be emitted at the end of the consumption period, meaning delayed to the end of the content consumption. In one set of embodiments of the development, the notification can merely be delayed, while retaining its initial rendering.

On the contrary, in some embodiments the notification may be both delayed and altered. For example, an alert sound emitted at low intensity during consumption can be emitted at high intensity after consumption. A delayed and/or altered notification can comprise, in some embodiments, an indication (visual and/or audible) indicating to the user that it is a delayed/altered notification.

In some embodiments, where it is configured so that a notification has a (so-called initial) rendering duration in the absence of content consumption, depending on the embodiments the delayed notification can be rendered either according to its initial duration or according to a duration that is reduced in comparison to this initial duration. For example, a first configurable duration can be used for non-delayed notifications rendered when no content is being consumed, and a second configurable duration, shorter than the first duration, can be used for delayed notifications rendered at the end of the content consumption. Delayed notifications can also be rendered for a duration equal to a fraction or percentage of the non-delayed rendering duration.

If several notifications are delayed during content consumption, in one set of embodiments of the development they can be rendered at the end of the content consumption, either independently of each other or in a group. Notifications can be grouped in different ways. For example, they can be grouped by types of notifications, by application, by various characteristics related to the notifications (for example, by message sender or by conversation for text notifications), etc.

In the example illustrated in FIG. 2, step 230 therefore comprises, when content is being consumed in an environment of the device, limiting at least one notification on at least one human-machine interface of the device.

For example, when a user is reading an email, writing a text, listening to a podcast, or reading the newspaper, the notifications can be limited.

This can help to avoid disrupting the concentration of a user of the device during content consumption, while allowing him or her to benefit from notifications when no content is being consumed.

According to some embodiments, the limitation of notifications can apply to all of the notifications, or only to some of the notifications.

For example, in some embodiments, the limitation can apply only to notifications issued by a specific application or applications (for example those belonging to a first list of applications (for example configurable)), and/or only to certain type(s) of notification (for example text notifications, audio notifications, etc.).

Conversely, in some embodiments, the limitation of notifications can apply to all notifications except certain notification(s), for example notifications from at least one given application, messages from at least one given user, etc.

The limitation of notifications can also vary (for example apply or not apply) according to a priority level of the notifications. The notifications can thus be classified according to a priority level, which can be defined for example by a priority label (for example “priority”, “important”, “urgent” for a high-priority notification, or “non-priority”, “low priority” for a less important notification) or a priority index. In such embodiments, the notifications considered high priority or urgent cannot for example be limited or delayed.

Such embodiments can help to limit notifications in general during content consumption, while always benefiting from certain notifications (for example considered particularly important).

In some embodiments, the type of notifications that are or are not to be limited can be configured, for example by a user of the device.

In some embodiments of the development, method 200 can comprise detecting a start of said consumption upon detecting an access to said content.

In other words, in such embodiments, the start of content consumption, and therefore of the limitation of notifications, is considered to occur upon detecting an access to the content. Such embodiments can help to detect the start of content consumption as early as possible, and limit notifications at the very start of consumption.

Detecting the access to content can be achieved in various ways. For example, this can involve detecting the opening of a file, detecting the start of streaming from multimedia networks, or detecting the presence of physical content external to the device via glasses such as glasses 100c.

In some embodiments of the development, the method may comprise, following a detection of access to a content, a characterization 220 of the content. The limitation can for example be conditional on its characterization. Such embodiments can for example help to pace the limitation of notifications issued to a user according to the complexity of the content consumed, and therefore to the level of concentration that this content potentially requires from the user in order to understand it properly.

Characterization of content corresponds to obtaining one or more characteristics of the content. Examples of content characteristics may include, for example:
a type of environment in which the content is consumed. For example, whether it is content accessed locally on the device, received via a multimedia stream, or content on a physical medium that is separate from the device;
a type of content (computer text, email, podcast, music, video, physical newspaper, etc.),
content complexity. For example, in some embodiments of the development, in the case of electronic text, the content can be considered simple if the text consists of a list of simple words, for example a shopping list. In contrast, the text can be considered complex if it is a poem or a philosophical essay. Complexity can be expressed in different ways, for example as a complexity index, or as a complexity value (e.g., “simple”, “moderately complex”, “complex”. Text complexity can be estimated in different ways, for example depending on the length of the words, the diversity of the lexical field used, the rarity of the words in the text, etc.;
length of the content;
etc.

These examples are provided solely as non-limiting examples of the characteristics of consumable content only. More generally, any characterization capable of providing characteristics relating to the experience of a user when consuming content can be used in the context of this development. The characterization can relate to one or more characteristics.

The dependency of a limitation on said characterization means that the limitation is dependent on the characteristics of the content. In other words, limitation of a notification can only be carried out, in such embodiments, when the content has at least a first characteristic, for example a first characteristic among predefined characteristics. For example, limitation can be carried out only if:
the content belongs to one or more given types, for example only if the content is text or video; and/or
the content has a complexity greater than or equal to a first complexity level (for example a predefined threshold value). For example, limitation can only be carried out for complex content (complexity can for example be defined by the rarity or diversity of the vocabulary used in a text, the language of the text, the speed of a video, etc.); and/or
the content has a duration greater than or equal to a first duration (for example a predefined duration, the content duration being definable for example by a number of words/characters for text, a duration for video or audio content). For example, limitation of a notification can only be carried out for content considered to be long.

Limitation can also only be carried out as a function of a duration and/or complexity of the content. For example, the complexity thresholds beyond which limitation is carried out can depend on the length of the content, limitation being applied for example for long and moderately complex content, but also for short content of high complexity.

Thus, in some embodiments, method 200 can comprise a step 220 of characterizing the content, and a verification 221 that the characteristics of the content correspond to at least one content characteristic for which notifications are to be limited, the limitation in step 230 being activated only in this case. Otherwise, no limitation is applied, until a next step 210 of detecting access to content.

Depending on the embodiments, characterization of the content can be carried out one time, for example when opening the content, or several times.

A single characterization of the content makes it possible, for example, to characterize content, such as an email, a text, or short multimedia content, when it is opened and for its entire use.

Characterization carried out several times makes it possible to adapt the characterization of the content, and the limitation of notifications, to content whose characteristics are likely to evolve over time. For example, characterization can be performed in real time/at regular intervals on an audio/video file being played, or an audio/video stream, to real-time dialogue, whose complexity characteristics can vary over time, etc. This therefore makes it possible to adapt the limitation of notifications to variations in the content characteristics.

Of course, these examples of links between content characteristics and limitation are provided solely as non-limiting examples, and the dependency of limitation on characterization can apply to any type of characteristic, or combination of characteristics. For example, limitation may be performed only for particularly complex and lengthy text content.

Such embodiments can, for example, help with limiting notifications solely for content requiring special attention for a given user.

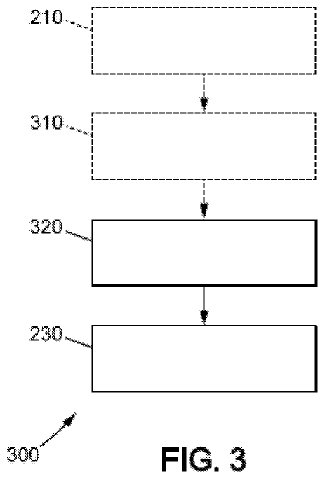

FIG. 3 shows a second example of the method according to some embodiments.

Method 300 comprises step 230, and optionally step 210, of method 200.

In some embodiments of the development, said limitation can be implemented for a duration which takes into account said consumed content.

To this end, in the example of FIG. 3, method 300 can comprise a step 320 of obtaining (for example calculating or estimating) a limitation duration, for example taking into account the content in particular, and an implementation of limitation step 230 occurs during the limitation duration obtained (unless the content consumption ends).

Notifications can thus be limited during the estimated duration. In examples where the limitation of a notification includes delaying the notification, the delayed notification can be rendered, in its original form or in an altered form, at the end of the limitation duration as obtained in step 320.

In other words, in some embodiments of the development, taking the consumed content into account can help to determine (obtain) a limitation duration, which can for example correspond to an estimated duration of content consumption. This duration can be estimated from the content itself.

For example, the duration can correspond to:
a duration of a multimedia file. For example, when opening a multimedia file, the duration of the content consumption, and therefore the duration during which notifications are to be limited, can be estimated as the duration of the file. The duration of the file can for example be identified in the metadata of a multimedia file, or evaluated for a text file on the basis of the number of words and/or characters;
a duration of a sequence of a multimedia file. For example, in the case of a video file, the duration of the notification limitation could correspond to the duration of the file minus the duration of the end credits. The end credits can be detected if the file comprises chapters, or by using a text detector in the video;
a length of a text. In this case, the duration for reading the text by a user is estimated on the basis of its length. The duration for reading the text can be determined for example according to the user's estimated speed of reading the text, which can be a predefined speed or a speed associated with the user, for example during a calibration phase. The speed can also be estimated on the basis of one or more parameters which may include a basic speed, the semantic richness of a text (more complex text being considered longer to read), a user's state of fatigue, stress, or concentration which can for example be estimated through measurements from physiological sensors, etc.;
a combination of the above examples.

These examples are provided solely as non-limiting examples. More generally, any consumption duration associated with a consumed content (in particular a duration estimated directly from the content itself) can be used in this context.

Such embodiments can, for example, help with limiting notifications solely during the period in which the file will probably be consumed.

In some embodiments of the development, the limitation duration is at least a function of the size of the content.

The size of the content can be understood here to be the size of a content to be scanned by the user's eye.

For example, the size of the content can comprise one or a combination of the following sizes:
the size of a digital image, expressed for example as the number of pixels, area, width, height, etc.;
the size of a text, expressed for example as the number of words, number of characters, number of lines, font, etc.
the size of the content's physical paper medium, expressed in width, height, area, etc.

These examples are given solely as non-limiting examples of the size of content; the size of content can more generally correspond to any measurement representing a size of content to be scanned by the eye of a user of the computing device.

Size can also be calculated as a combination of sizes, for example when content includes both text and images.

Such embodiments can, for example, help to obtain a more precise estimate of the time to consume the content, in the case of content that must be scanned by the eye of a user, and therefore limit notifications solely when the user is actively consuming this content.

The limitation duration can for example be a function of the size in combination with one or more other parameters, such as reading speed for example.

In some embodiments of the development, when the content includes text data, said limitation duration can be at least a function of a length of the text data.

As indicated above, the size of the text data can for example correspond to one or more sizes chosen among a number of words, a number of characters, a number of lines, a font, etc.

Such embodiments can, for example, help to estimate the consumption duration for a text file (or a textual component of a file), and therefore to limit notifications solely when a user is probably reading text.

In some embodiments of the development, the limitation duration can be at least a function of a rate of consumption of said content.

The rate of consumption of content represents the speed at which a user reviews the content. It can for example be estimated as:
a number of characters read per unit of time;
a number of words read per unit of time;
an image area scanned per unit of time;
a combination of the above examples.

These examples are given solely as non-limiting examples. Generally, any speed estimated as a content size read per unit of time can be used.

The rate of consumption of content can be estimated before the fact, or measured, for example by means of eye tracking methods. For example, method 300 can comprise, prior to step 320, a step 310 of estimating the reading speed of the consumer.

Such embodiments can for example help to improve an estimate of the content consumption time, and therefore to define the content limitation duration in a more precise manner, and thus to adapt the limitation duration for notifications, according to the user's needs.

In some embodiments of the development, when the content includes text data, said limitation duration is at least a function of an estimated text reading speed.

As indicated above, the estimated text reading speed can be expressed as text length per unit of time.

This can therefore help to more reliably evaluate the reading time of a text, and therefore help to limit notifications within the actual reading time of the text.

The text reading speed can be estimated in different ways. For example:
The speed can be predefined:
   as a default speed or configuration speed;
      as a reading speed of a user, estimated during a calibration phase. The calibration phase can be carried out in different ways. For example, a user can read a reference text by pressing a button to signify that reading has started and ended. It is also possible that the user reads a text aloud, in order to estimate the reading time of the reference text. In both cases, the user's reading speed can be estimated, for example by dividing the size of the reference text by the reading time obtained;
      the speed can take into account the complexity of the text. It can for example take a first value or a second value depending on the complexity of the text, or the user can have carried out several calibration phases for different complexities or complexity intervals;
      the reading speed can be estimated in real time, for example by measuring the user's scrolling speed, or the speed of eye movement via an eye tracking device.

Depending on the embodiments, step 310 of estimating a consumer's reading speed can be performed for each content after detecting access to this content, or during a calibration phase prior to content consumption (for example during an initialization phase of the method or during a customization phase of the method, for its adaptation to a user profile).

These examples are given solely as non-limiting examples, and in general the user's reading speed can be estimated by any method which allows obtaining the user's default reading speed, based on text content and/or real-time measurements.

These methods can also be combined. For example, an initial default reading speed can be obtained, then corrected in real time by means of measurements.

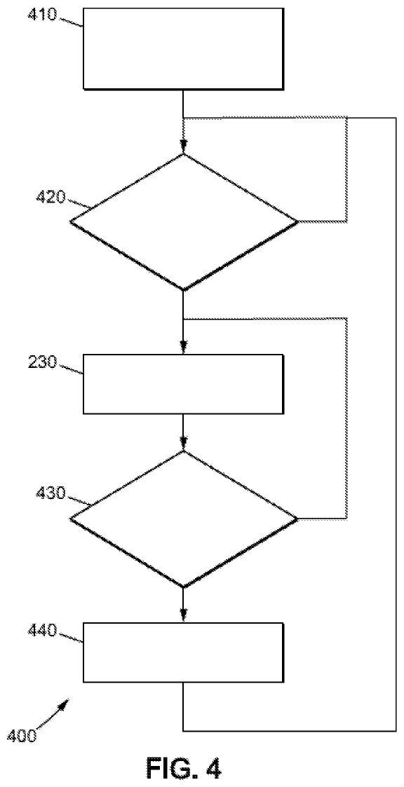

FIG. 4 shows a third example of a method according to some embodiments of the development.

In some embodiments of the development, the method comprises detecting the start of content consumption and/or monitoring consumption via an analysis of measurements coming from at least one sensor for sensing activity of a consumer of said content.

In other words, at least one sensor can help determine user activity concerning the content. This can help to detect the start of consumption and/or to monitor consumption, i.e.:
when the measurements of the at least one sensor indicate activity of the consumer concerning the content, the start of content consumption can be detected;
once the start of consumption can be detected, the consumption can be tracked, and the limitation of notifications maintained as long as the measurements of the at least one sensor indicate activity of the consumer concerning the content.

Such embodiments can for example help to assess in real time whether the consumer, who may in particular be a user of the computing device, is consuming content, and therefore can help to limit real-time notifications solely when the user is consuming content.

Thus, method 400 may comprise, in some embodiments:
receiving 410 measurements from the at least one activity sensor;
detecting 420, based on the measurements, the start of consumption based on the measurements from at least one activity sensor;
if the measurements from the at least one activity sensor indicate that content consumption has started, step 230 of limiting the at least one notification;
otherwise, returning to detection step 420.

Thus, the limitation of the at least one notification is only triggered when content consumption has started.

Method 400 can also comprise, in combination or not in combination with steps 410 and 420:
“continuous” detection 430 of consumption in progress. This consists of verifying (for example periodically), based on measurements made at different times and received in real time by the at least one activity sensor, whether or not content consumption is in progress;
if content consumption is in progress, maintaining the limitation of the at least one notification in step 230;
otherwise, a step 440 of ending the limitation of the at least one notification, which can be followed by a return to step 420 of detecting the start of consumption.

Thus, steps 430 and 440 make it possible to check continuously, once the limitation of the at least one notification has been implemented, that content consumption is in progress, and to stop limiting the current notification as soon as the consumer has finished consuming the content.

If notifications have been delayed, they can for example be rendered to the user in step 440 of ending the limitation.

The at least one sensor for sensing activity of the content consumer can be any type of sensor whose measurements allow determining whether the consumer is consuming content. For example, this may be:
a sensor whose measurements allow detecting the presence of the consumer. For example, such a sensor can be a camera allowing the user's face facing the camera, a presence sensor, a position sensor embedded in a mobile device worn by the user such as a smart watch, smart glasses, or a smart phone, thus making it possible to detect that the user is near the computing device, etc.
a sensor to detect consumer activity on the device, related to the content consumed, such as a keyboard, mouse, or eye tracking device. In this case, the detection of scrolling, an action on the keyboard, or movement of the eyes over the content allows verifying that the consumer is indeed consuming the content;
a sensor enabling the detection of a user action on a physical medium that is separate from the at least one human-machine interface on which the content is rendered. For example, a camera embedded in glasses such as glasses 100c allows detecting that the user of the glasses is consuming content on a physical medium that is separate from the glasses, for example if the user is writing on a sheet, turning the pages of a book or newspaper, or scrolling on a touchscreen in a public place.

These examples are given solely as examples, and more generally any sensor whose measurements allow determining whether the consumer is consuming content can be used. Sensor measurements can also be combined. For example, eye tracking may be triggered only if a presence sensor indicates that the user is near the device.

In the case of content accessed electronically, the measurements of the at least one sensor may be taken into account solely when access to the content is detected. For example, eye tracking, for the purposes of detecting consumption of a file or of a multimedia stream, may be implemented upon detecting access to the file or to the multimedia stream.

As indicated above, in some embodiments of the development, the measurements coming from the at least one activity sensor include tracking of the consumer's eyes.

For example, eye tracking can be performed on the basis of images supplied by a webcam, or on the basis of video cameras integrated into glasses such as glasses 100c.

Eye tracking offers the advantage of making it possible, at least in some embodiments, to detect that a user of the device is in the process of consuming content by tracking the gaze of this user, whether the content is computer text, a video file or stream, or content rendered on a physical medium separate from the human-machine interface, such as a newspaper, a book, a blank page, or an external touchscreen.

Eye tracking can be performed in different ways. Depending on the embodiments, all known eye tracking techniques can be used.

The eye tracking can be configured by default to detect activity of the user's eyes, or conversely can be adapted to a given situation.

For example, in some embodiments of the development which comprise a characterization of the content, the analysis of eye tracking measurements can at least be a function of said characterization of the content.

In other words, the type of eye tracking and/or the tracking parameters depend on the characteristics of the content. For example:
different eye tracking methods can be used for different types of content (for example, a first eye tracking method for text content, and a second other eye tracking method for video content);
tracking parameters can vary according to the complexity or type of content. For example, different parameter values can be applied if the expected speed of the eye movement is low (complex text, slow video), or conversely if the expected speed of the eye movement is higher (list formatted for easy understanding, action movie video, etc.).

Configuration of eye tracking according to the characterization of content can help to make detecting content consumption by the consumer more precise, since the method and/or the detection parameters are adapted to the characteristics of the content.

Methods 200, 300, and 400 are provided solely as non-limiting examples of methods according to some embodiments of the development.

Other embodiments can be considered. In particular, the method according to various embodiments of the development may comprise only some of the steps of methods 200, 300, and 400, or a combination of these steps.

For example, a method according to the development can comprise both an estimation of the limitation duration in step 320, and a monitoring of consumption in steps 430 and 440.

Thus, in some embodiments, the notifications may be limited for a duration estimated on the basis of the content, as soon as the start of consumption is detected; notifications are subsequently rendered without limitation (for those still active). Similarly, in some embodiments, notifications may be limited only for the duration estimated on the basis of the content, as long as monitoring indicates that the consumer is consuming the content.

The steps of methods 300 and 400 may also be preceded by step 210 and/or steps 220 and 221. Thus, the steps of methods 300 and 400 may be triggered solely when access to the content is detected, and if the characteristics of the content require limiting the at least one notification.

In some embodiments of the development, at least part of the content may be rendered on a physical medium that is separate from the human-machine interface.

The physical medium can thus be an electronic medium, for example an electronic screen, or a non-electronic medium, for example a sheet of paper.

Depending on the embodiments, content consumption can equally well comprise reading content, for example reading a newspaper or watching a video, and writing content, for example handwriting text on a sheet of paper.

The content consumption (for example non-electronic) can be carried out by sight, for example via glasses such as glasses 100c.

In some embodiments of the development, the content consumption thus comprises at least one element among reading and writing of content in text form.

The present technical solutions can be applied in particular in the field of human-machine interfaces, in any computing device capable of issuing notifications via at least one human-machine interface.

This disclosure is not limited to the method, device, computer program, and computer storage medium examples described above solely by way of example, but encompasses all variants conceivable to those skilled in the art, in the context of the protection sought.

1. A method implemented by a computing device, the method comprising:
a limitation of a rendering of at least one notification on at least one human-machine interface of the device when a content is being consumed in an environment of the device.

2. The method according to claim 1, the limitation comprising delaying the rendering of the at least one notification.

3. The method according to claim 1, the method comprising a characterization of the content, and the limitation is conditional on the characterization.

4. The method according to claim 1, wherein the limitation is implemented for a duration which takes at least into account the consumed content.

5. The method according to claim 4, the duration of the limitation taking at least account of a size of the content.

6. The method according to claim 4, the duration of the limitation taking at least account of a rate of consumption of the content.

7. The method according to claim 5, the duration of the limitation taking at least account of an estimated text reading speed when the content comprises text data.

8. The method according to claim 1, the method comprising detecting a start of the consumption and/or monitoring the consumption via an analysis of measurements coming from at least one activity sensor for sensing activity of a consumer of the content.

9. The method according to claim 7, the measurements comprising eye tracking for the consumer.

10. The method according to claim 8, comprising a characterization of the content, the limitation being conditional on the characterization, and the analysis of eye tracking measurements taking at least account of the characterization of the content.

11. The method according to claim 1, the content being rendered on a physical medium that is separate from the at least one human-machine interface.

12. A computing device comprising at least one processor configured to implement a limitation of a rendering of at least one notification on at least one human-machine interface of the device when a content is being consumed in an environment of the device.

13. The computing device according to claim 12, the limitation comprising delaying the rendering of the at least one notification.

14. The computing device according to claim 12, the limitation being implemented for a duration which takes at least into account the consumed content.

15. The computing device according to claim 14, the duration of the limitation taking at least account of a size of the content.

16. The computing device according to claim 14, wherein the duration of the limitation taking at least account of a rate of consumption of the content.

17. The computing device according to claim 15, the duration of the limitation taking at least account of an estimated text reading speed when the content comprises text data.

18. The computing device according to claim 12, the content being rendered on a physical medium that is separate from the at least one human-machine interface.

19. A non-transitory, computer-readable storage medium on which is stored a computer program comprising instructions for implementing, when the program is executed by a processor of a computing device, a limitation of a rendering of at least one notification on at least one human-machine interface of the computing device when a content is being consumed in an environment of the device.

20. The non-transitory, computer-readable storage medium of claim 19, the limitation comprising delaying the rendering of the at least one notification.
